(19) United States
(12) Patent Application Publication
(10) Pub. No.: US 2018/0163624 A1
(43) Pub. Date: Jun. 14, 2018

(54) SYSTEMS AND METHODS FOR GAS TURBINE COMPRESSOR CLEANING

(71) Applicant: General Electric Company, Schenectady, NY (US)

(72) Inventors: Candida Lopez, Houston, TX (US); Randall John Kleen, Houston, TX (US); Harley Matthew Ross, Houston, TX (US); Ely Edgardo Tejeda, Queretaro (MX); Ravishankar Bagalur Sampangiramaiah, Greenville, SC (US); Susheelkumar Cherangara, Greenville, SC (US); Venkata Bandaru, Greenville, SC (US); Feng Gao, West Chester, OH (US)

(21) Appl. No.: 15/377,604

(22) Filed: Dec. 13, 2016

(51) Int. Cl. F02C 3/30; F02C 3/04

(52) U.S. Cl. CPC F02C 3/30; F02C 3/04

(57) ABSTRACT

In one embodiment, a gas turbine fluid wash system includes a fluid wash system controller comprising a processor. The processor is configured to receive a cleaning fluid flow demand from a turbine system controller, wherein the turbine system controller is configured to control the turbine system to produce power. The processor is additionally configured to provide a cleaning fluid flow based on the cleaning fluid flow demand transmitted by the turbine system controller.

### BACKGROUND OF THE INVENTION

The subject matter disclosed herein relates to gas turbine compressors, and more specifically, to systems and methods for cleaning of gas turbine compressors.

Gas turbine systems typically include a compressor for compressing a working fluid, such as air. The compressed air is injected into a combustor, which heats the fluid causing it to expand, and the expanded fluid is forced through a turbine. As the compressor consumes large quantities of air, small quantities of dust, aerosols and water pass through and deposit on the compressor (e.g., deposit onto blades of the compressor). These deposits may impede airflow through the compressor and degrade overall performance of the gas turbine system over time. Therefore, gas turbine engines may be periodically washed to clean and remove contaminants from the compressor; such operations are referred to as an offline wash operation or an online wash operation. The offline wash operation is performed while the gas turbine engine is shutdown. Contrarily, the on-line water wash operation allows the compressor wash to be performed while the engine is in operation, but may not recover the performance as well as the offline wash operation. There is a desire, therefore, for water wash systems that provide for more effective cleaning of turbine compressors, and improves water wash methods and systems.

### BRIEF DESCRIPTION OF THE INVENTION

In one embodiment, a gas turbine fluid wash system includes a fluid wash system controller comprising a processor. The processor is configured to receive a cleaning fluid flow demand from a turbine system controller, wherein the turbine system controller is configured to control the turbine system to produce power. The processor is additionally configured to provide a cleaning fluid flow based on the cleaning fluid flow demand transmitted by the turbine system controller.

In a second embodiment, a method for producing power is provided, that includes operating a turbine system to combust a fuel and produce a power, and performing an online wash on the gas turbine system. Performing the online wash comprises receiving a demand for a cleaning fluid flow from a turbine system controller via a fluid wash system, wherein the turbine system controller is configured to control the turbine system to produce the power. Performing the online wash system additionally includes providing, via the fluid wash system, the cleaning fluid flow based on the demand by actuating a flow control system, a pressure increasing system, or a combination thereof, disposed in the fluid wash system.

In a third embodiment, a tangible, non-transitory computer-readable media storing computer instructions thereon is provided. The computer instructions when executed by a processor included in a fluid wash system cause the processor to perform an online wash on a gas turbine system. The online wash comprises receiving, via the processor, a demand for a cleaning fluid flow from a turbine system controller, wherein the turbine system controller is configured to control the turbine system to produce the power. The online wash further comprises providing, via the processor, the cleaning fluid flow based on the demand by actuating a flow control system, a pressure increasing system, or a combination thereof, disposed in the fluid wash system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a power generation system and a fluid wash system, which may include portable embodiments;

FIG. 2 is a schematic of an embodiment of the fluid wash system of FIG. 1;

FIG. 3 is perspective view of an embodiment of the fluid wash system of FIG. 2;

FIG. 4 is another perspective view of an embodiment of the fluid wash system of FIG. 2;

FIG. 5 is block diagram of an embodiment of the fluid wash system of FIG. 2; and

FIG. 6 is an embodiment of a process suitable for online wash of a gas turbine system included in the power generation system of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

When turbine system users (e.g., power producing utilities) encounter low performance in turbine systems and the low performance is due to accumulated grime or, in general, dirtiness, one of the recommendations to improve performance is to perform a water wash on turbine engines. Such a water wash may recover the lost performance. The techniques described herein provide for an assembly, which in one embodiment may include a mobile cart, suitable for water wash operations that may be performed while the turbine system is in operation, e.g., online water washing. The assembly may be equipped with heated tank as well as with pump and flow control devices suitable for providing electronically controlled variable cleaning fluid flow at desired temperatures. The assembly may also include sensors that provide for a closed loop process that would provide a desired fluid flow control, as described in more detail below.

The assembly may include a compact form factor and features for ease of lifting (e.g., via forklift and/or cranes) and improved handling (e.g., wheels for manual and/or mechanical handling). The assembly may also include connectors suitable for connecting to an industrial controller, and a processing system that may collaborate with the industrial controller. The industrial controller may operate the turbine system while simultaneously the mobile cart's processing system (e.g., wash system controller) may interact with the industrial controller to control a washing fluid flow during online wash operations in a more efficient and portable manner. By providing for an assembly with techniques suitable to interface with external systems (e.g., the industrial controller) and for providing mobile and accessible operations, the techniques described herein may result in improved water wash operations.

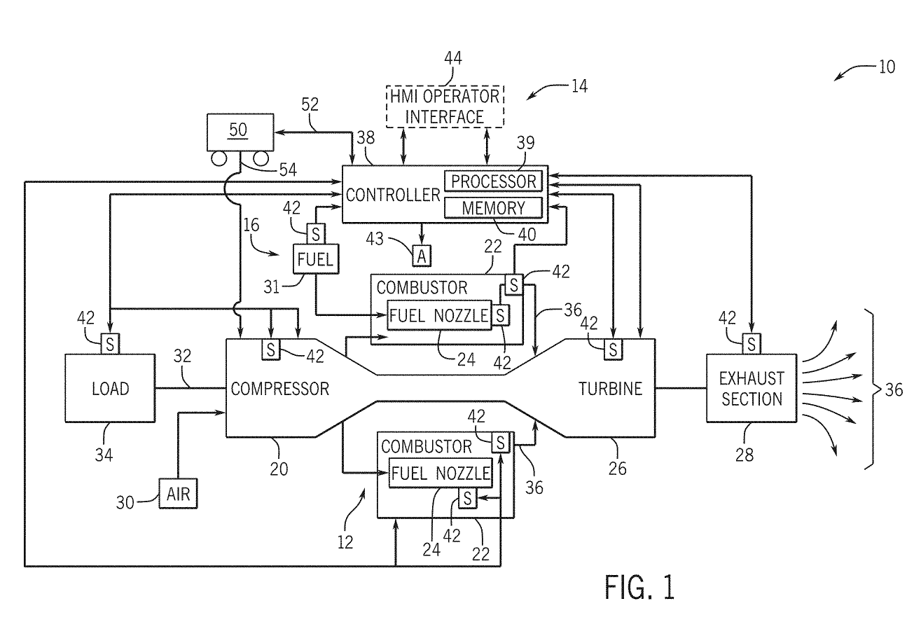

It may be beneficial to describe a turbine system, such as the industrial system 10, which may benefit from water wash operations. Turning now to FIG. 1, the figure is a diagram illustrating the industrial system 10, such as a power plant, that includes a gas turbine system 12, a monitoring and control system 14, and a fuel supply system 16. The gas turbine engine or system 12 may include a compressor 20, combustion systems 22, fuel nozzles 24, a gas turbine 26, and an exhaust section 28. During operation, the gas turbine system 12 may pull an oxidant such as air 30 into the compressor 20, which may then compress the air 30 and move the air 30 to the combustion system 22 (e.g., which may include a number of combustors). The air 30 may encounter an inlet guide vane system 31 having vanes that may be positioned at a variety of angles to optimize intake of the air 30 and operations of the gas turbine system 12.

In the combustion system 22, the fuel nozzle 24 (or a number of fuel nozzles 24) may inject fuel that mixes with the compressed air 30 to create, for example, an air-fuel mixture. The air-fuel mixture may combust in the combustion system 22 to generate hot combustion gases, which flow downstream into the turbine 26 to drive one or more turbine stages. For example, the combustion gases may move through the turbine 26 to drive one or more stages of turbine blades, which may in turn drive rotation of a shaft 32. The shaft 32 may connect to a load 34, such as a generator that uses the torque of the shaft 32 to produce electricity. After passing through the turbine 26, the hot combustion gases may vent as exhaust gases 36 into the environment by way of the exhaust section 28. The exhaust gas 36 may include gases such as carbon dioxide (CO₂), carbon monoxide (CO), nitrogen oxides (NOₓ), and so forth.

In certain embodiments, the system 10 may also include a controller 38. The controller 38 may be communicatively coupled to a number of sensors 42, a human machine interface (HMI) operator interface 44, and one or more actuators 43 suitable for controlling components of the system 10. The actuators 43 may include valves, switches, positioners, pumps, and the like, suitable for controlling the various components of the system 10. The controller 38 may receive data from the sensors 42, and may be used to control the compressor 20, the combustors 22, the turbine 26, the exhaust section 28, the load 34, and so forth.

In the current embodiments, data from the sensors 42 may be collected for use in water washing, such as online washing. The sensor data may then be converted into turbine engine 12 parameters to be used, as further described below, to direct the controller 38 and a fluid wash system 50, which may include portable embodiments, to perform an improved online water wash while the turbine engine 12 continuous operations. For example, data (e.g., sensor 42 data) and/or commands may be communicated via an electrical conduit system 52, and the fluid wash system 50 may then direct metered washing fluid (e.g., water), which may be determined by the turbine engine 12 parameters, via a fluid conduit system 54 into the compressor 20.

In certain embodiments, the HMI operator interface 44 may be executable by one or more computer systems of the system 10. A plant operator may interface with the industrial system 10 via the HMI operator interface 44. Accordingly, the HMI operator interface 44 may include various input and output devices (e.g., mouse, keyboard, monitor, touch screen, or other suitable input and/or output device) such that the plant operator may provide commands (e.g., control and/or operational commands) to the controller 38. Further, operational information from the controller 38 and/or the sensors 42 may be presented via the HMI operator interface 44. Similarly, the controller 38 may be responsible for controlling one or more final control elements coupled to the components (e.g., the compressor 20, the turbine 26, the combustors 22, the load 34, and so forth) of the industrial system 10 such as, for example, one or more actuators, valves, transducers, and so forth.

In certain embodiments, the sensors 42 may be any of various sensors useful in providing various operational data to the controller 38. For example, the sensors 42 may provide pressure and temperature of the compressor 20, speed and temperature of the turbine 26, vibration of the compressor 20 and the turbine 26, CO₂ levels in the exhaust gas 36, carbon content in the fuel 31, temperature of the fuel 31, temperature, pressure, clearance of the compressor 20 and the turbine 26 (e.g., distance between the compressor 20 and the turbine 26 and/or between other stationary and/or rotating components that may be included within the industrial system 10), flame temperature or intensity, vibration, combustion dynamics (e.g., fluctuations in pressure, flame intensity, and so forth), load data from load 34, output power from the turbine 26, and so forth.

The controller 38 may include a processor(s) 39 (e.g., a microprocessor(s)) that may execute software programs to perform the disclosed techniques. Moreover, the processor 39 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 38 may include a memory device 40 that may store information such as control software, look up tables, configuration data, etc. The memory device 40 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 40 may store a variety of information, which may be suitable for various purposes. For example, the memory device 40 may store machine-readable and/or processor-executable instructions (e.g., firmware or software) for the processor execution. In one embodiment, the instructions, when executed, cause the processor 39 to collaborate with the fluid wash system 50 to perform an online wash of certain components of the turbine system 12, such as the compressor 20. By providing for certain wash processes described further below implementable via the controller 38 and the fluid wash system 50, the techniques described herein may provide for an improved online wash that may recover performance and power production for the industrial system 10.

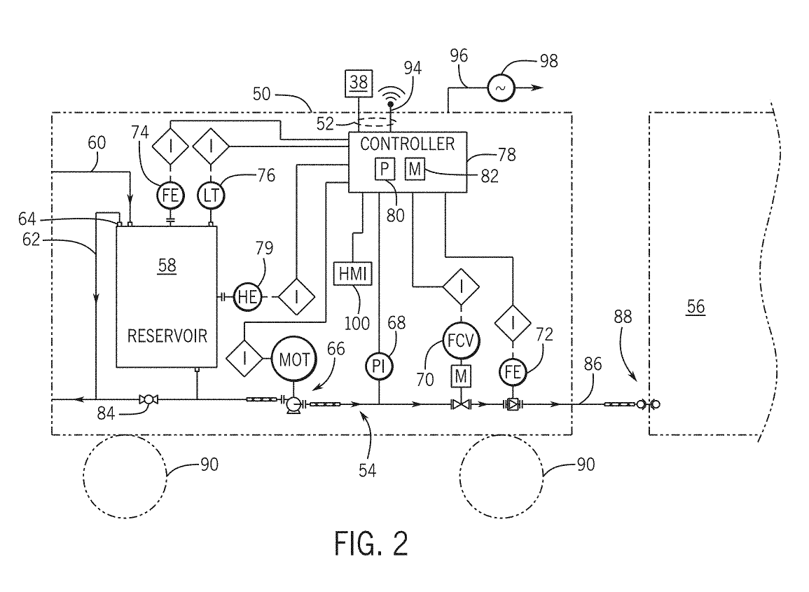

FIG. 2 is a block diagram illustrating an embodiment of the fluid wash system 50 fluidly coupled to a gas turbine interface 56 included in the gas turbine 12. In the depicted embodiment, the fluid wash system 50 includes a fluid reservoir 58 suitable for storing wash fluids, such as water. To fill the reservoir 58, a conduit 60 may be used. For example, a pump may be connected from a water source via the conduit 60 and used to transfer water into the reservoir 58. In cases of overflow, an overflow conduit 62 is provided. The overflow conduit 62 may include an overflow valve 64 that may open when fluid pressure reaches a certain value.

The fluid wash system 50 may provide washing fluid to the gas turbine interface 56 via the fluid conduit system 54. In the depicted embodiment, the fluid conduit system 54 may include a pressure increasing system (e.g., motor/pump) 66, a pressure sensor 68, a flow control system 70, and a flow measuring element 72 (e.g., vortex flow sensor). It is to be understood that the embodiment for the fluid conduit system 54 show is for example only, and other embodiments may include one or more pressure increasing systems 66, pressure sensors 69, flow control system 70, other valve types, flow sensors, and so on.

Further, the portable fluid wash system 50 may include one or more temperature sensors 74 and one or more level sensors 76. The pressure increasing system 66, pressure sensor 68, flow control valve 70, flow measurement element 72, temperature sensor(s) 74, and level sensor(s) 76 may be communicatively coupled to a controller 78. The controller 78 may additionally include one or more processors 80 and one or more memories 82. The processor(s) 80 (e.g., a microprocessor(s)) may execute software programs to perform the disclosed techniques. Moreover, the processor 80 may include multiple microprocessors, one or more “general-purpose” microprocessors, one or more special-purpose microprocessors, and/or one or more application specific integrated circuits (ASICS), or some combination thereof.

For example, the processor 80 may include one or more reduced instruction set (RISC) processors. The memory device 82 that may store information such as control software, look up tables, configuration data, etc. The memory device 82 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 82 may store a variety of information, which may be suitable for various purposes. For example, the memory device 82 may store machine-readable and/or processor-executable instructions (e.g., firmware or software) for the processor execution. In one embodiment, the instructions, when executed, cause the processor 80 to collaborate with controller 38 to perform an online wash of certain components of the turbine system 12, such as the compressor 20. Indeed, while the controller 38 is controlling operations for the industrial system 10 (e.g., gas turbine 12), the controller 78 may be collaborating with the controller 38 to control the delivery of metered wash fluid to the gas turbine interface 56, which may then provide the wash fluid to certain components or sections of the gas turbine 12 (e.g., compressor 20) based on current gas turbine parameters.

In one embodiment, when a flow control function for the conduit system 54 fails or receives an out of the flow requirement, the pressure increasing system 66 would be subject of a dead head operation point (e.g., fully blocked). In this embodiment, a feature such as a pressure relief valve 84 would prevent the pressure increasing system 66, for example, from overheating. The flow control function may use the flow control system (e.g., flow throttling valve) 70 and the flow measuring element or sensor 72 and may be implemented as computer instructions executable via the processor 80 and stored in the memory 82. In certain embodiments, the flow control function may be implemented as a proportional integral differential (PID) control loop that may receive, for example, a setpoint such as a flow setpoint, pressure setpoint, temperature setpoint, or combination thereof, communicated from the industrial controller 38.

The flow control system 72 may consist of a valve ball with flow resistance against current handle angular position. This ball valve may be actuated electrically with an enclosure motor that receives signal, such as an analog 4-20 mA signal that commands the valve 72 to open to a determined valve handle position within the 0 to 90 degrees range. The position of the valve 70 may be determined by the controller 78. Other valve types may also be used, as well as multiple valves or other techniques for controlling flow.

The flow measuring element 72 may consist of a turbine type magnetic pulse flow meter that converts the magnetic pulses of a metallic turbine spinning within the flow to a 4-20 mA signal that is communicated to the controllers 38 and/or 78. The controller 78 may receive the signal from the flow meter 72, convert it to a flow value, and compare it to the actual demand for wash fluid being sent from the controller 38 according to the current gas turbine system 12 operation. If a difference between the demand and the current measured flow exist, the controller may then adjust the flow of wash fluid by continuously manipulating the flow control system 70. A heating system 79 is also provided, such as an electric heater. The heating system 79 may heat the washing fluid in the reservoir 58 to a desired temperature range. In one example, the range may be between 140 F—By adding thermal energy to the washing fluid, the heating system 79 may enable more efficient operations for the gas turbine system 12 when compared to washing fluid having no added thermal energy.

A conduit section 86 may include a flexible hose used to route liquid into the gas turbine interface 56. A mechanical interface such as a quick disconnect coupling 88, may connect the conduit section 86 to the gas turbine interface 56, so that it can be easily connected to another gas turbine interface 56 of a different gas turbine system 12. Also shown are a plurality of wheels 90 that may be used to move the fluid wash system 50 into a desired location near the gas turbine interface 56. The wheels 90 may be removable, thus enabling the fluid wash system 50 to be more fixedly positioned at a desired location. For example, the wheels 90 may be removed after positioning the portable fluid wash system 50 (or before) at the desired location. The fluid wash system 50 may also include certain features, described in more detail below, to tow and/or otherwise position the fluid wash system 50.

Embodiment may include a wired conduit 92 and/or a wireless conduit 94 included in the electrical conduit system 52. The wired conduit 92 may include communication cables and the like, suitable for interfacing the controller 78 to the controller 38. The wireless conduit 94 may include wireless techniques, such as Wi-Fi (e.g., IEEE 802.11x), Bluetooth, wireless mesh networking (e.g., ZigBee, Z-Wave, WeMo). Power conduit(s) 96 are also provided, which may provide electrical power delivered via a power source 98. The power source 98 may be included in the industrial system 10 and/or the gas turbine system 12. In certain embodiments, Quick Disconnects with a special key way may be included in the conduits 92, 96. The special key way may minimize or eliminate incorrect couplings between the fluid wash system 50 and the controller 38 and/or power source 98. An HMI 100 may also be included, suitable for operating the fluid wash system 50. The HMI 100 may include physical switches, dials, levers, and so on, as well as gauges, touchscreens, displays, and the like, suitable for providing for inputs and for displaying various measurements and the like.

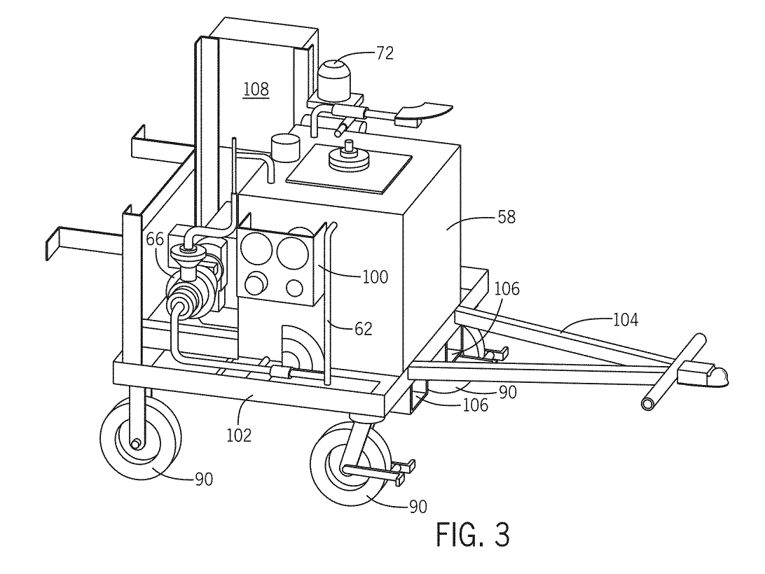

Turning now to FIG. 3, the figure is a perspective view illustrating an embodiment of the portable fluid wash system 50. Because the figure utilizes like elements to those found in FIGS. 1 and 2, the like elements are shown with like numbers. In the depicted embodiment, the fluid wash system 50 includes a frame 102 and may have the wheels 90. The fluid wash system 50 also includes a tow bar 104 coupled to the frame 102, suitable for mounting the portable fluid wash system 50 onto a hitch, such as a vehicle tow hitch, to move the fluid wash system 50 into a desired location. The depicted embodiment may have members 106, such as rectangular members, suitable for use in positioning the fluid wash system 50, for example, via a forklift. Forklift arms or blades may be disposed inside of members 106, and the forklift may then lift the fluid wash system 50 and move the portable fluid wash system 50 into the desired location.

As mentioned earlier, the wheels 90 may be removable. Accordingly, the fluid wash system 50 may be placed onto the desired location, and the wheels 90 removed for a more long-term positioning. Once positioned, the fluid wash system 50 may be connected to the gas turbine system 12 and engaged. The HMI 100 may be used to start up and/or to adjust operations of the fluid wash system 50, and the HMI 100 controls may interface with the controller 78 disposed inside of a housing 108. Also shown are portions of the pressure increasing system 66 (e.g., pump), the conduit system 62 and the flow sensor 72.

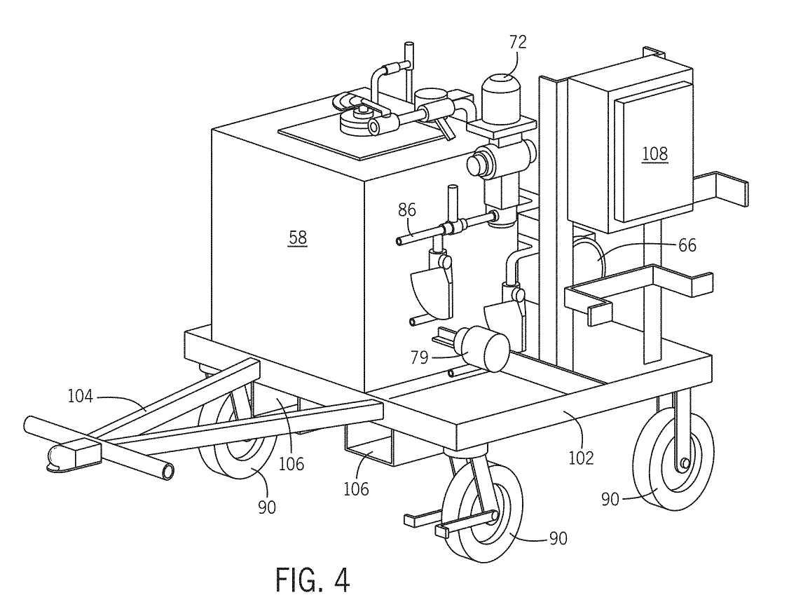

FIG. 4 is a perspective view illustrating an embodiment of the portable fluid wash system 50. Because the figure utilizes like elements to those found in FIGS. 1, 2 and 3, the like elements are shown with like numbers. The figure illustrates a side opposite to that illustrated in FIG. 3. In the depicted embodiment, the portable fluid wash system 50 includes the frame 102 having the wheels 90. The portable fluid wash system 50 has the reservoir 58 disposed on the frame 102. On a side of the reservoir 58 the heating system 79 is illustrated. As mentioned earlier, the heating system 79 may add thermal energy to fluid stored in the reservoir 58. The fluid may include water and/or glycol, for example.

In one embodiment, the online wash techniques described herein may be provided by combining the controllers 78 and 38 into a single controller, where one set of instructions is used to control the gas turbine system 12 and a second set of instructions is used to control the fluid wash system 10. In this embodiment, the combined controller may be disposed in the gas turbine system 12 and communicatively coupled to actuators and sensors of the fluid wash system 10, or disposed in the fluid wash system 10 and communicatively coupled to actuators and sensors of the gas turbine system 12.

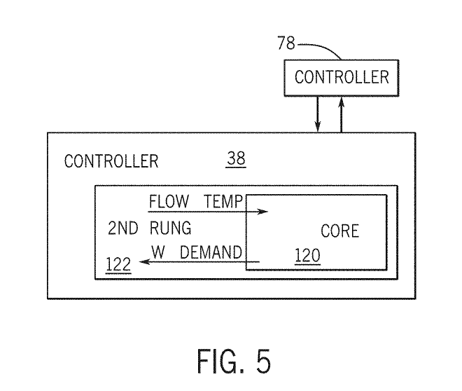

During operations, the end user may communicatively couple the controller 78 (which may be housed in the enclosure 108) to the controller 38 of the gas turbine engine system 12. Power (e.g., auxiliary electrical power produced via the gas turbine engine 12 or other power source) may also be provided to the fluid wash system 50. Fluid section 86 may also be fluidly coupled to the gas turbine interface 56, and the portable fluid wash system 50 may be turned on. The controllers 78 and 38 may then initiate a communication and begin wash operations, as described in more detail below with respect to FIG. 5.

FIG. 5 illustrates a block diagram of embodiments of the controller 78 and the controller 38 communicatively coupled to each other. In the depicted embodiment, the controller 38 may include a core section 120 and a second rung section 122. The core section 120 may include processes and/or systems (e.g., processors and memories) that may be used to control the gas turbine system 12, and that may provide deterministic control. For example, processes executed by the core section 120 may be deterministic processes with macrocycles that are substantially guaranteed to complete execution inside of a given time range. Further, each of the deterministic processes may always finish substantially at about the same time. Control processes may include operating the gas turbine system 12 by adding fuel, air, and the like, at desired flow values. The second rung section 122 may include auxiliary processes and/or systems (e.g., processors and memories) that may be used to support the core section 122 and to provide for certain auxiliary control and/or control of auxiliary systems.

During operations, the core section 120 may be operating the gas turbine engine system 12 to provide a desired power (e.g., 50 Megawatts) while online wash operations are also simultaneously ongoing. Such online wash enables the power production system 10 to continue to produce power while the gas turbine system 12 is being cleaned. During operations, the core section 120 may derive a desired cleaning fluid flow (e.g., W_{demand}) into the gas turbine system 12. The desired cleaning fluid flow (e.g., W_{demand}) may be communicated via the second rung section 122, which in turn may communicate it to the controller 78. The controller 78 may then respond by engaging the pressure increasing system 66 and/or modulating one or more elements (e.g., flow control system 70) to provide the desired cleaning fluid flow (e.g., W_{demand}). Actual flow and actual temperature for the cleaning fluid may then be observed via sensors 72, 74, and communicated to the controller 38. More specifically, the controller 38 may communicate certain measurements (e.g., Flow, Temp) to the second rung section 122 which may then communicate the measurements to the core section 120. The core section 120 may then incorporate the measurements (e.g., Flow, Temp) into control algorithms used to determine a fuel flow, air flow, and the like, suitable for providing the desired power. Accordingly, a feedback loop may be enabled, wherein the controller 38 requests the desired cleaning fluid flow (e.g., W_{demand}) to the controller 78, the controller 78 actuates certain flow systems (e.g., flow control system 70) and/or pressure increasing systems (e.g., system 66), and communicates measurements representative of the fluid being delivered (e.g., flows, temperatures, and/or pressures of the cleaning fluid). By incorporating the closed loop between the fluid wash system 50 and the gas turbine controller 38, a more efficient online wash operation may be enabled that provides for cooperation between the gas turbine system 12 control (e.g., controller 38) and the online wash control (e.g., controller 78), thus improving engine operations while online wash is occurring, and cleaning the gas turbine system 12 more efficiently. Indeed, by incorporating measurements for the cleaning fluid entering the gas turbine system 12 (e.g., fluid flow, fluid temperature, fluid pressure, fluid composition) and by requesting changes in the fluid properties (e.g., higher or lower flows, temperatures, pressures, and/or fluid compositions), the controller 38 may include the cleaning fluid properties in model based control of the gas turbine system 12, thus enabling a more accurate and efficient control.

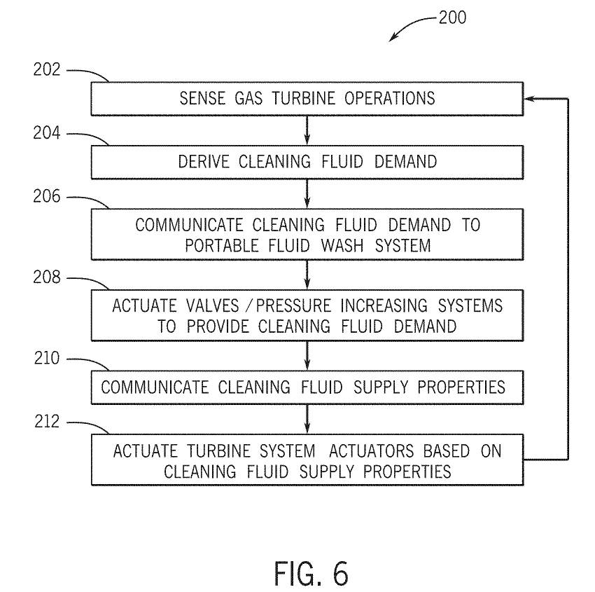

FIG. 6 is a flowchart illustrating an embodiment of a process 200 suitable for performing an online wash of the gas turbine system 12. The process 200 may be implemented as computer code or instructions executable by the processor(s) 39, 80 and stored in the memories 40, 82. In the depicted embodiment, the process 200 may sense (block 202) power system 10 operations. For example, sensor 42 data, including fuel type data, fuel flow data, other flow data (e.g., air flow), temperatures, pressures, clearances (e.g., distances between a stationary and a rotating component), speed, velocity, inlet guide vane (IGV) 31 position, IGV system 31 loss, exhaust system 28 flows, auxiliary loads, and so on. Data may also include maintenance data, such as type of maintenance that may have been performed before online wash, such as blade replacement/repair, and so on. Data collected may also include ambient conditions (e.g., temperature, humidity, atmospheric pressure). The data may be obtained (block 202) for a fleet of turbine systems 12. For example, the same or similar model numbers for the turbine system or engine 12 may be grouped together and data obtained for the group. In one non-limiting example, the turbine system 12 model may be a LM6000 gas turbine system available from General Electric Co. of Schenectady, N.Y. Accordingly, data for certain (or all) LM6000 gas turbines 12 may be collected (block 202).

As mentioned, the gas turbine system 12 is operating during online wash. Accordingly, the controller 38 may control the gas turbine system 12, for example, by controlling fuel flows, air flows, combustion properties, and the like. The controller 38 may execute one or more models, such as physics-based models such as thermodynamic models, low cycle fatigue (LCF) life prediction models, computational fluid dynamics (CFD) models, finite element analysis (FEA) models, solid models (e.g., parametric and non-parametric modeling), and/or 3-dimension to 2-dimension FEA mapping models that may be used to predict the behavior of the gas turbine system 12. Models may also include artificial intelligence (AI) models, such as expert systems (e.g. forward chained expert systems, backward chained expert systems), neural networks, fuzzy logic systems, state vector machines (SVMs), inductive reasoning systems, Bayesian inference systems, or a combination thereof.

The controller 38 may derive (block 204) a cleaning fluid demand. For example, the controller 38 may execute the aforementioned models used in controlling the gas turbine system 12 to derive (block 204) the cleaning fluid demand. In one example, thermodynamic fluid flow modeling may be used to determine a desired cleaning fluid flow, pressure, temperature, composition (e.g., chemical composition such as glycol percentage in water), or a combination thereof. The controller 38 may then communicate (block 206) the desired cleaning fluid flow, pressure, temperature, composition (e.g., chemical composition such as glycol percentage in water), or the combination thereof, to the controller 80 included in the fluid wash system 50.

The controller 80 may then use the transmitted desired cleaning fluid flow, pressure, temperature, composition (e.g., chemical composition such as glycol percentage in water), or the combination thereof to actuate (block 208) one or more elements or systems (e.g., flow control system 70), and/or to control (block 208) one or more pressure increasing systems (e.g., system 66) and/or heating systems (e.g., heating system 79) to provide for the desired cleaning fluid flow, pressure, temperature, composition (e.g., chemical composition such as glycol percentage in water), or the combination thereof.

As the cleaning fluid is delivered to the gas turbine system 12, one or more sensor measurements may be taken by the controller 80 and communicated (block 210) to the controller 38. For example, the sensor 72 may be used to measure cleaning fluid flow, and other sensors may be used to sense pressures, temperatures, composition, and so on, and then communicated (block 210) to the controller 38. The controller 38 may then use the communicated data (e.g., cleaning fluid flows, pressures, temperatures, and so on) as inputs to the one or more models used to control the gas turbine system 12, and then actuate (block 212) one or more gas turbine system 12 actuators (e.g., valves, pumps, guide vanes, and so on) to adjust control of the gas turbine system 12. By incorporating feedback from the wash system 50, the gas turbine system 12 may be more efficiently operated and cleaned.

Technical effects of the invention include techniques for improving online washing, and in an exemplary embodiment, portable systems for online wash operations, for a turbine system. In one embodiment, a gas turbine controller may communicate a desired cleaning fluid flow rate, temperature, pressure, and/or composition to a fluid wash system. The fluid wash system may then provide a cleaning fluid at the desired flow rate, temperature, pressure, and/or composition. The portable fluid wash system may additionally measure certain properties of the delivered cleaning fluid (e.g., flow rate, temperature, pressure, composition) and transmit the measurements to the gas turbine controller. The gas turbine controller may incorporate the transmitted measurements as inputs to a model and apply the model to adjust gas turbine system operations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gas turbine fluid wash system, comprising:
a fluid wash system controller comprising a processor, wherein the processor is configured to:
receive a cleaning fluid flow demand from a turbine system controller, wherein the turbine system controller is configured to control the turbine system to produce power; and
provide a cleaning fluid flow based on the cleaning fluid flow demand transmitted by the turbine system controller.

2. The system of claim 1, comprising:
a fluid wash assembly comprising:
a fluid reservoir configured to store a cleaning fluid;
a frame, wherein the fluid reservoir is disposed on the frame;
a flow control system;
a pressure increasing system fluidly coupled to the fluid reservoir and to the flow control system and configured to provide the cleaning fluid to a gas turbine system through the flow control system; and
the fluid wash system controller comprising the processor, wherein the processor is configured to provide the cleaning fluid flow by actuating the pressure increasing system, the flow control system, or the combination thereof, to deliver the cleaning fluid from the fluid reservoir.

3. The system of claim 1, wherein the processor is configured to execute the instructions to communicate to the turbine system controller a measured cleaning fluid flow rate, a measured cleaning fluid temperature, a measured cleaning fluid pressure, a cleaning fluid composition, or a combination thereof, during gas turbine online cleaning operations.

4. The system of claim 3, comprising the turbine system controller, wherein the turbine system controller is configured to receive the measured cleaning fluid flow rate, the measured cleaning fluid temperature, the measured cleaning fluid pressure, the cleaning fluid composition, or the combination thereof, and to adjust operations of the turbine system based on the measured cleaning fluid flow rate, the measured cleaning fluid temperature, the measured cleaning fluid pressure, the cleaning fluid composition, or the combination thereof.

5. The system of claim 2, comprising a heating system coupled to the fluid reservoir and configured to heat the cleaning fluid.

6. The system of claim 5, wherein the processor is configured to control the heating system heat the cleaning fluid at a temperature setpoint.

7. The system of claim 1, comprising one or more electrical conduits configured to communicatively couple the fluid wash system controller to the turbine system controller.

8. The system of claim 2, wherein the frame comprises one or more wheels configured to contact a ground.

9. The system of claim 8, wherein the one or more wheels comprise removable wheels.

10. The system of claim 1, wherein the frame comprises at least two members configured to accept a forklift arm inserted into each member.

11. A method for producing power, comprising:
operating a gas turbine system to combust a fuel and produce a power;
performing an online wash on the gas turbine system, wherein performing the online wash comprises:
receiving a demand for a cleaning fluid flow from a turbine system controller via a fluid wash system, wherein the turbine system controller is configured to control the turbine system to produce the power; and
providing, via the fluid wash system, the cleaning fluid flow based on the demand by actuating a flow control system, a pressure increasing system, or a combination thereof, disposed in the fluid wash system.

12. The method of claim 11, comprising transmitting from the fluid wash system to the turbine system controller, a measured cleaning fluid flow rate, a measured cleaning fluid temperature, a measured cleaning fluid pressure, a cleaning fluid composition, or a combination thereof.

13. The method of claim 12, comprising adjusting, via the turbine system controller, turbine system operations based on the measured cleaning fluid flow rate, the measured cleaning fluid temperature, the measured cleaning fluid pressure, the cleaning fluid composition, or the combination thereof.

14. The method of claim 13, wherein adjusting, via the turbine system controller, turbine system operations, comprises executing a turbine system model using as inputs to the turbine system model the measured cleaning fluid flow rate, the measured cleaning fluid temperature, the measured cleaning fluid pressure, the cleaning fluid composition, or the combination thereof.

15. The method of claim 14, wherein the turbine system model comprises a thermodynamic model of the turbine system modeling fluid flows and combustion in a combustor included in the turbine system.

16. The method of claim 11, comprising positioning the fluid wash system to a turbine system site having the gas turbine system, fluidly coupling the fluid wash system to the gas turbine system, and communicatively coupling the fluid wash system to the turbine system controller.

17. A tangible, non-transitory computer-readable media storing computer instructions thereon, the computer instructions, when executed by a processor included in a fluid wash system, cause the processor to:
perform an online wash on a gas turbine system, wherein the online wash comprises:
receiving, via the processor, a demand for a cleaning fluid flow from a turbine system controller, wherein the turbine system controller is configured to control the turbine system to produce the power; and
providing, via the processor, the cleaning fluid flow based on the demand by actuating a flow control system, a pressure increasing system, or a combination thereof, disposed in the fluid wash system.

18. The computer-readable media of claim 17, comprising instructions that when executed by the processor cause the processor to transmit to the turbine system controller a measured cleaning fluid flow rate, a measured cleaning fluid temperature, a measured cleaning fluid pressure, a cleaning fluid composition, or a combination thereof.

19. The computer-readable media of claim 18, comprising instructions that when executed by a second processor included in the turbine system controller cause the second processor to adjust turbine system operations based on the measured cleaning fluid flow rate, the measured cleaning fluid temperature, the measured cleaning fluid pressure, the cleaning fluid composition, or the combination thereof.

20. The computer-readable media of claim 17, comprising instructions that when executed by the processor cause the processor to heat the cleaning fluid to a setpoint temperature via a heating system included in the fluid wash system.
